(19) United States
(12) Patent Application Publication
(10) Pub. No.: US 2026/0097647 A1
(43) Pub. Date: Apr. 9, 2026

(54) ELECTRIC AXLE

(71) Applicant: Dana Automotive Systems Group, LLC, Maumee, OH (US)

(72) Inventors: Jens SCHNEBELE, Petersburg, MI (US); Matteo SCRIBANO, Rivoli (IT)

(21) Appl. No.: 19/348,610

(22) Filed: Oct. 2, 2025

Related U.S. Application Data
(60) Provisional application No. 63/703,599, filed on Oct. 4, 2024.

(51) Int. Cl. B60K 17/08; B60B 35/12; B60K 1/00; B60K 17/02; B60K 17/16

(52) U.S. Cl. CPC B60K 17/08; B60B 35/125; B60K 1/00; B60K 17/02; B60K 17/165

(57) ABSTRACT

A system and method for an electric axle. The electric axle system includes, in one example, a traction motor, a first shaft rotationally coupled to the traction motor via one or more gear reductions, and a second shaft arranged coaxial to the first shaft and rotationally coupled to a differential. The electric axle system further includes a clutch configured to in a higher speed position, rotationally couple the first shaft and the second shaft and in a lower speed position, rotationally couple the first shaft to a sun gear in a compound planetary gear set and rotationally couple a ring gear in the compound planetary gear set to the second shaft.

### CROSS-REFERENCE TO RELATED APPLICATION

The present application claims priority to U.S. Provisional Application No. 63/703,599, entitled “ELECTRIC AXLE”, and filed on Oct. 4, 2024. The entire contents of the above-listed application are hereby incorporated by reference for all purposes.

### TECHNICAL FIELD

The present disclosure relates to an electric axle with a multi-speed planetary gear set.

### BACKGROUND AND SUMMARY

Segments of the vehicle market are moving towards electrification. The inventors have recognized a need to further increase electric powertrain compactness and power output in a cost effective package. Attempts have been made to develop electric axles for hybrid and all-electric vehicle platforms. Electric axles include motors, gear trains, and differentials that are packaged together for delivering power to drive wheels.

The inventors have recognized that certain vehicle platforms demand both on and off-road performance characteristics that involve undesirable tradeoffs. To elaborate, in off-road environments, comparatively high torque at low speed may be desired that results in lower on-road powertrain efficiency.

The inventors have recognized the abovementioned challenges and developed an electric axle to at least partially overcome the challenges. The electric axle system includes, in one example, a traction motor, a first shaft that is rotationally coupled to the traction motor via one or more gear reductions and a second shaft arranged coaxial to the first shaft and rotationally coupled to a differential. The electric axle system further includes a clutch configured to, in a higher speed position, rotationally couple the first shaft and the second shaft and in a lower speed position, rotationally couple the first shaft to a sun gear in a compound planetary gear set and rotationally couple a ring gear in the compound planetary gear set to the second shaft. Further, in the electric axle system, the compound planetary gear set and the differential are coaxially arranged. Additionally, in the electric axle system the compound planetary gear set includes a first set of planet gears that mesh with the sun gear and a second set of planet gears that mesh with the ring gear. In this way, a modular electric axle architecture is achieved in a space efficient layout that is able to efficiently operate in higher and lower speeds modes that allow the axle to be used in a wider variety of operating environments. Additionally, the use of a compound planetary gear set in the electric axle allows the traction motor to rotate in one rotational direction while the axle is operated in both gear modes and achieve a space efficient package with target gear ratios for both modes of operation.

In one example, the clutch may be configured to, in a neutral position, rotationally decouple the sun gear from the first shaft, rotationally decouple the ring gear from the second shaft, and rotationally decouple the first shaft from the second shaft. In this way, the functionality of the clutch is expanded and enables losses in the electric axle to be reduced during certain operating conditions, thereby increasing electric axle efficiency.

In another example, during the shift the clutch between the higher speed position and the lower speed position, the clutch is moved into a synchronization position where a speed of the sun gear is synchronized with a speed of the first shaft. This synchronization may occur when shifting at non-zero speeds. As a result, noise, vibration, and harshness (NVH) during shifting transients is reduced.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 is a schematic depiction of an example of an electric axle.

FIG. 2 is a perspective view of an example of an electric axle.

FIGS. 3A-3B are cross-sectional views of the electric axle, depicted in FIG. 2, in a lower gear configuration and a higher gear configuration, respectively.

FIGS. 4A-4C are detailed illustrations of a clutch that is included in the electric axle, depicted in FIG. 2, in different positions.

### DETAILED DESCRIPTION

A multi-speed electric axle is described herein that achieves a target gear range for operating at lower speeds (e.g., such as in off-road environments) and higher efficiency in higher speed range when compared to previous electric axle designs. The multi-speed electric axle, in one example, includes a clutch that is configured to in a higher range position, rotationally couple a first shaft and a second shaft (that is coupled to a differential) to bypass a compound planetary gear set. Conversely, the clutch is configured to, in a lower range position, rotationally couple the second shaft to a sun gear in the compound planetary gear set and rotationally couple a ring gear in the compound planetary gear set to the second shaft. Further, the abovementioned electric axle architecture enables the axle to achieve higher power density, high ground clearance, and poses less spatial constraints on surrounding steering and suspension components. Further, the abovementioned electric axle architecture achieves increased modularity, if desired. To elaborate, selected gear reductions in the gear train may be removed, if desired, for certain vehicle platforms.

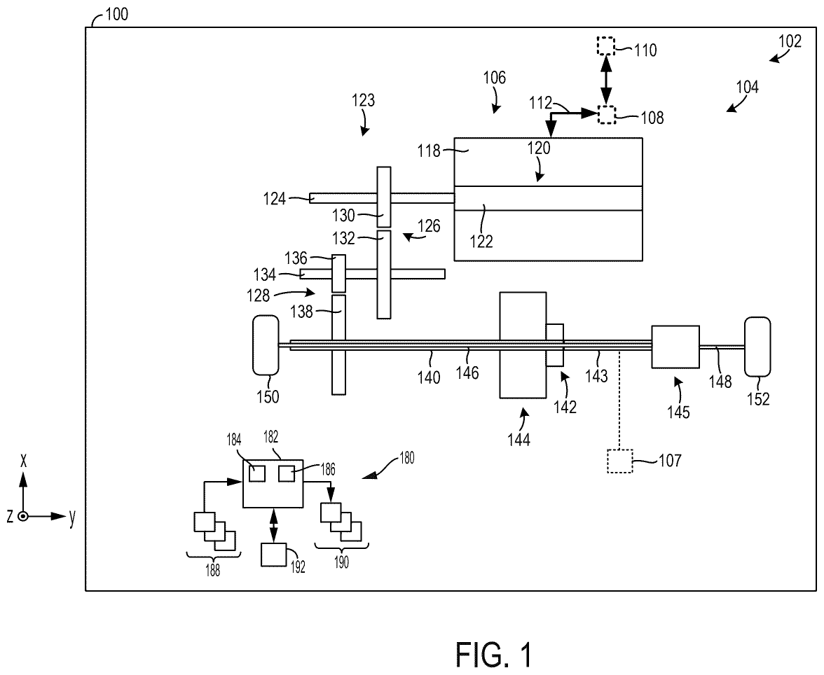

FIG. 1 shows an electric vehicle (EV) 100 that includes a powertrain 102 with an electric axle 104. As such, The EV 100 is a hybrid EV in the illustrated example. Further, in some examples another axle in the vehicle may be driven by an internal combustion engine (ICE) and/or the ICE may be configured to charge a traction battery and/or other suitable energy storage device. Even further, in other examples, the EV 100 may be an all-electric vehicle (e.g., battery electric vehicle (BEV)) where the ICE is omitted.

As described herein an electric axle is an electric drive incorporated into an axle. The electric axle may be an electric beam axle, in one example. In another example, the electric axle may be an independent axle. Further, a beam axle is an axle with mechanical components structurally supporting one another and extending between drive wheels. For instance, the beam axle may be a structurally continuous structure that spans the drive wheels on a lateral axis, in one embodiment. Thus, wheels coupled to the beam axle substantially move in unison when articulating, during, for example, vehicle travel on uneven road surfaces. To elaborate, the camber angle of the wheels may remain substantially constant as the suspension moves through its travel. The electric axle 104 may be coupled to a suspension system 107, in one example. To elaborate, the suspension system 107 may be a dependent suspension system, in the beam axle example. Therefore, the electric axle may be an unsprung mass in the beam axle example. However, in the independent axle example, the suspension system 107 may be an independent suspension system.

The electric axle 104 includes a traction motor 106. The traction motor 106 may be an electric motor-generator, for example. For instance, the traction motor 106 may be designed as a multi-phase alternating current (AC) motor-generator. As such, the traction motor 106 and the other traction motors described herein may be operated in a regeneration mode. However, in other examples, the electric machine may be a motor without generator capabilities.

As illustrated in FIG. 1, the traction motor 106 may be electrically coupled to an inverter 108. The inverter 108 is designed to convert direct current (DC) electric power to alternating current (AC) electric power and vice versa. Therefore, the traction motor 106 may be an AC electric machine, as previously indicated. However, in other examples, the electric machine may be a DC electric machine and the inverter may therefore be omitted from the electric drive, in such an example. The inverter 108 may receive electric energy from one or more energy storage device(s) 110 (e.g., traction batteries, capacitors, combinations thereof, and the like). Arrows 112 signify the electric energy transfer between the traction motor 106, the inverter 108, and the energy storage device(s) 110 that may occur during different modes of electric axle operation (e.g., a drive mode and a regeneration mode). As such, during a drive mode, electric energy may flow from the energy storage device(s) 110 to the traction motor 106 and during a regeneration mode, electric energy may flow in the opposite direction from the electric machine to the energy storage device(s). The inverter 108 may be integrated into the electric axle 104, in one example.

The traction motor 106 includes a stator 118 and a rotor 120 that includes a rotor shaft 122. The electric axle 104 further includes a gear train 123. The rotor shaft 122 is directly rotationally coupled to an input shaft 124, in the illustrated example. However, other suitable mechanical connections may be used to attach the traction motor to the gear train, in other examples.

The gear train 123 includes a first gear reduction 126 and a second gear reduction 128, in the illustrated example. However, the gear train 123 may include a greater of fewer number of gear reductions, in alternate examples. The number of gear reductions may be selected based on the target gear ratios for the axle's different operating modes.

The first gear reduction 126 includes a gear 130 that is rotationally coupled to the input shaft 124 such that it rotates therewith. Another gear 132 included in the first gear reduction 126 is rotationally coupled to an intermediate shaft 134 such that it rotates therewith. It will be understood that the gear 130 meshes with the gear 132. The gears described herein may be helical gears, in one example, or straight gears in another example.

The second gear reduction 128 includes a gear 136 that is rotationally coupled to the intermediate shaft 134 such that it rotates therewith. The second gear reduction 128 includes another gear 138 that is rotationally coupled to a shaft 140 such that it rotates therewith. It will be understood that the gear 136 meshes with the gear 138.

The electric axle 104 further includes a clutch 142 and a compound planetary gear set 144. As such, the compound planetary gear set includes a sun gear, a ring gear, and two or more sets of planetary gears that mesh with one another and a carrier on which the planet gears rotate. In the compound planetary gear set example, one set of planet gears meshes with the sun gear while another set of planet gears meshes with the ring gear.

The clutch 142, as elaborated upon herein, is configured to, in a first position, rotationally couple the shaft 140 and a shaft 143 that functions as an input for a differential 145 when the electric axle is operated in a drive mode and a regeneration mode. In this way, the mechanical power flow through the electric axle bypasses the planetary gear set 144, thereby increasing the operating efficiency of the axle due to the avoidance of losses in the compound planetary gear set. The clutch 142 is configured to, in a second position, rotationally couple the shaft 140 and a sun gear in the planetary gear set 144 and rotationally couple a ring gear in the planetary gear set and the shaft 143. In this way, mechanical power is routed through the compound planetary gear set to achieve a desired gear reduction. The clutch 142 may further be configured to operate in a neutral positon where power flow from the shaft 140 to downstream components is inhibited and vice versa. As such, the clutch 142 may be operated in the neutral position during coasting and flat towing, for example.

Axle shaft 146 and 148 are rotationally coupled to the differential 145 and drive wheels 150 and 152. The axle shaft 146 extends through central openings in the planetary gear set 144 and the shaft 140.

The EV 100 may also include a control system 180 with a controller 182. The controller 182 includes a processor 184 and memory 186. The memory 186 holds instructions stored therein that when executed by the processor 184 cause the controller 182 to perform the various methods, control techniques, etc., described herein. The processor 184 may include a microprocessor unit and/or other types of circuits. The memory 186 includes known data storage mediums such as random access memory, read only memory, keep alive memory, combinations thereof, and the like.

The controller 182 may receive various signals from sensors 188 positioned in different locations in the EV 100 and the multi-speed electric axle 104, more specifically. The sensors may include an electric machine speed sensor, energy storage device temperature sensor(s), clutch position sensors, energy storage device state of charge sensor(s), wheel speed sensors, and the like. The controller 182 may also send control signals to various actuators 190 coupled at different locations in the EV 100, and the multi-speed electric axle 104. For instance, the controller 182 may send signals to the inverter 108 to adjust the rotational speed of the traction motor 106. The other controllable components in the vehicle and powertrain may function in a similar manner with regard to command signals and actuator adjustment. For instance, the controller 182 may send signals to the clutch 142 to move the clutch into different positions to operate the axle in different modes, which are expanded upon herein. The controller and control system shown in FIG. 1 may be used in the other electric axles examples described herein. The controller may further be configured to command shifts between operating gears in a multi-speed gear train via clutch operation commands.

The EV 100 may also include one or more input device(s) 192 (e.g., an accelerator pedal, a brake pedal, a gear selector, a differential locker actuator, a console instrument panel, a touch interface, a touch panel, a keyboard, combinations thereof, and the like) in electronic communication with the controller 182. The input device(s) 192, responsive to operator input, may generate an acceleration adjustment request, a gear shift request when the electric axle includes a multi-speed gear train, and the like.

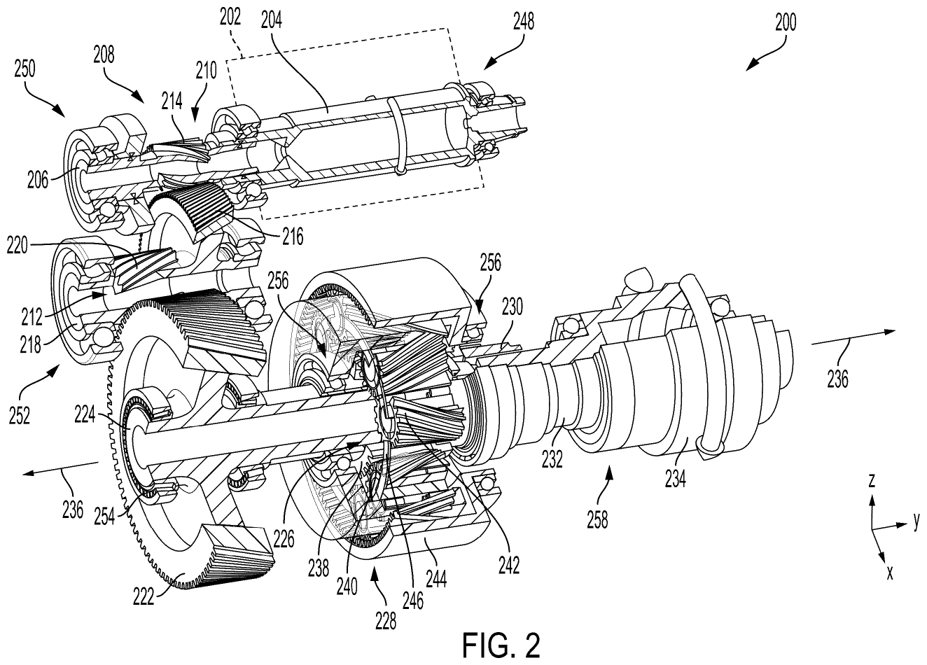

An axis system is provided in FIG. 1 as well as FIGS. 2-4C, for reference, when appropriate. The z-axis may be a vertical axis (e.g., parallel to a gravitational axis), the y-axis may be a lateral axis (e.g., horizontal axis), and/or the x-axis may be a longitudinal axis, in one example. However, the axes may have other orientations, in other examples.

FIG. 2 shows an example of an electric axle 200. The electric axle 200 serves as an example of the electric axle 104, shown in FIG. 1. Therefore, at least a portion of the structural and functional features from the electric axle 104 may be included in the electric axle 200 and vice versa.

The electric axle 200 includes a traction motor 202 with a rotor shaft 204 that is rotationally coupled to an input shaft 206. The electric axle 200 again includes a gear train 208 with a first gear reduction 210 and a second gear reduction 212. The first gear reduction 210 includes a gear 214 rotationally coupled to the input shaft 206 and a gear 216 rotationally coupled to an intermediate shaft 218. The second gear reduction 212 includes a gear 220 rotationally coupled to the intermediate shaft 218 and a gear 222 rotationally coupled to a shaft 224.

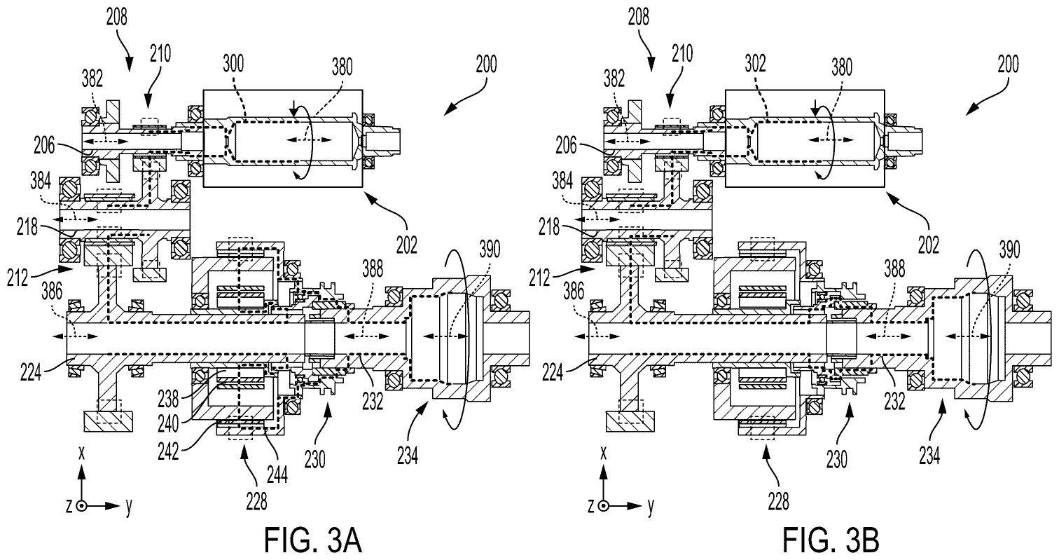

The shaft 224 extends through a central opening 226 of a planetary gear set 228, in the illustrated example. To elaborate, the shaft 224 is coupled to a clutch 230. As previously indicated, the clutch is configured to operate in multiple positions that allow the electric axle to operate in different modes, that are discussed in greater detail herein with regard to FIGS. 3A and 3B. Generally, the modes include a higher speed mode, a lower speed mode, a neutral mode, and a synchronization mode that may occur during shifting transients.

The clutch 230 is designed to selectively couple to a shaft 232 that functions as a rotational connection to a differential 234. The clutch 230 includes multiple couplings (e.g., sleeves) to achieve the different operating modes that are expanded upon in greater detail herein.

The differential 234 is configured to transfer mechanical power to drive wheels as denoted via arrows 236. The planetary gear set 228 includes a sun gear 238, a first set of planet gears 240 that mesh with the sun gear 238, a second set of planet gears 242 that mesh with a ring gear 244, and a carrier 246. The planet gears 240 and 242 are rotatably mounted on the carrier 246.

Bearings 248 are coupled to the rotor shaft 204, bearings 250 are coupled to the input shaft 206, bearings 252 are coupled to the intermediate shaft 218, bearings 254 are coupled to the shaft 224, bearings 256 are coupled to the planetary gear set 228, and bearings 258 are coupled to the differential, in the illustrated example. The bearings 256 may be conceptually included in the planetary gear set 228, in one example. Further, one of the bearings 256 may be arranged between the carrier 246 and the ring gear 244.

The clutch 230 is arranged axially between the differential 234 and the compound planetary gear set 228. In this way, the space efficiency of the axle is increased.

FIGS. 3A-3B show mechanical power paths through the electric axle 200 operating in a lower gear range and a higher gear range, respectively. The lower gear range may be referred to as a higher speed mode and the higher gear range may be referred to as a lower speed mode.

In FIG. 3A, the clutch 230 is in a position where the shaft 224 is rotationally coupled to the sun gear 238 and the ring gear 244 is rotationally coupled to the shaft 232. Conversely, in FIG. 3B, the clutch 230 is in a position where the shaft 224 is rotationally coupled to the shaft 232 such that power flow bypasses the planetary gear set 228.

The mechanical power paths 300 and 302 shown in FIGS. 3A and 3B each travel from the traction motor 202 to the first gear reduction 210, from the first gear reduction to the second gear reduction 212, and from the second gear reduction to the shaft 224. As such, power travels through the gear train 208 by way of the input shaft 206, the intermediate shaft 218, and the gears 214, 216, 220, and 222.

As shown in FIG. 3A, the power path 300 travels from the shaft 224 to the clutch 230, from the clutch 230 to the sun gear 238, from the sun gear to the planet gears 240, from the planet gears 240 (e.g., inner planet gears) to the planet gears 242 (e.g., outer planet gears), from the planet gears 242 to the ring gear 244, from the ring gear to the clutch 230, from the clutch 230 to the shaft 232, from the shaft 232 to the differential 234, and from the differential 234 to drive wheels by way of axle shafts.

As shown in FIG. 3B, the power path 302 travels from the shaft 224 to the clutch 230, from the clutch to the shaft 232, from the shaft 232 to the differential 234, and from the differential to the drive wheels by way of axle shafts.

Rotational axes 380, 382, 384, 386, 388, and 390 of the traction motor 202, the input shaft 206, the intermediate shaft 218, the shaft 224, the shaft 232, and the differential 234 are provided in FIGS. 3A-3B for reference. A shown in FIGS. 3A-3B axes 386, 388, and 390 are coaxially arranged in regard to one another.

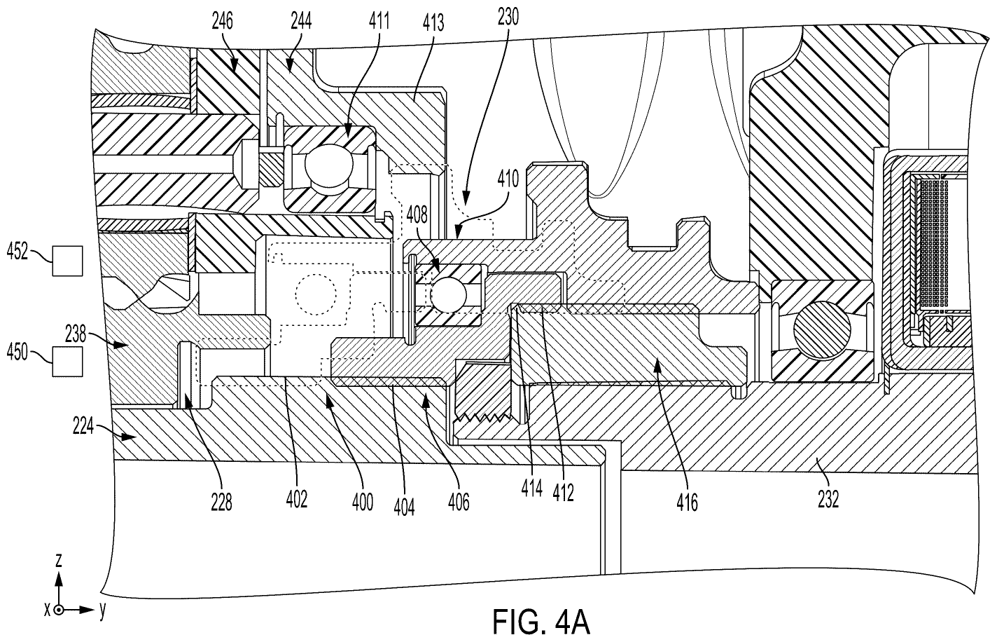

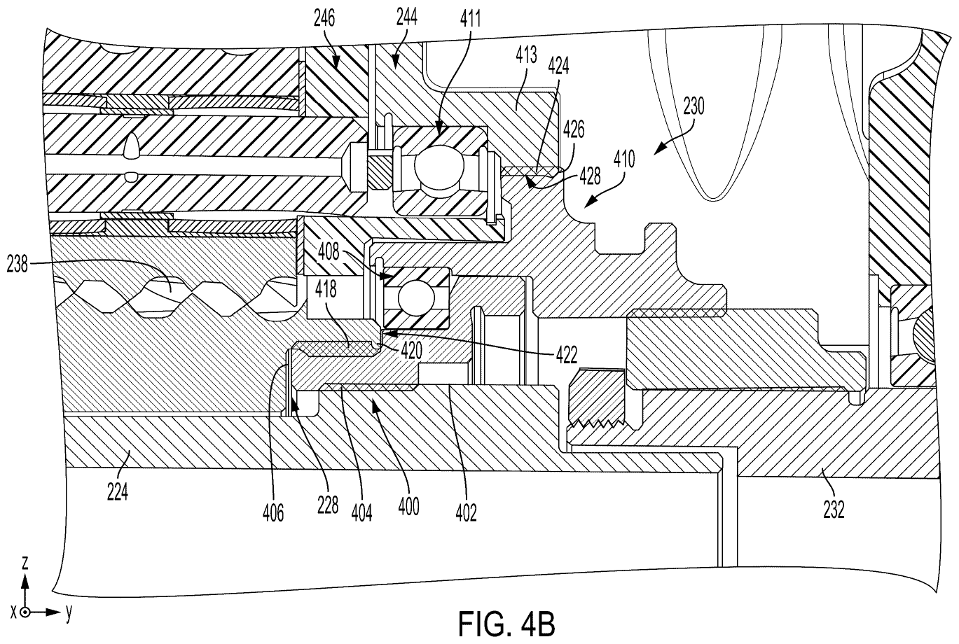

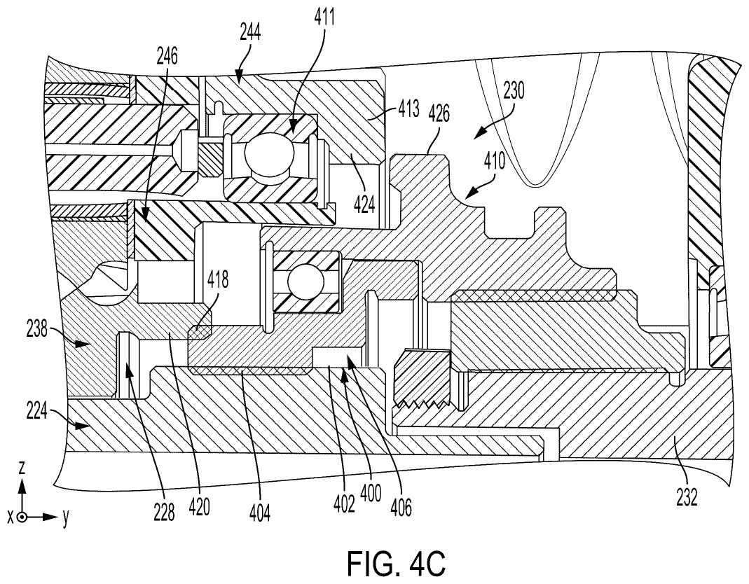

FIGS. 4A-4C show detailed views of the clutch 230 in different positions. The shaft 224 and the planetary gear set 228 are shown in FIGS. 4A-4C. The shaft 224 includes a splined section 400 with splines 402 that mate with splines 404 in a clutch sleeve 406 (e.g., an inner clutch sleeve) of the clutch 230. A bearing 408 is coupled to the clutch sleeve 406 of the clutch 230 and a clutch sleeve 410 (e.g., an outer clutch sleeve) of the clutch. In this way, the clutch sleeve 406 and the clutch sleeve 410 independently rotate. The bearing 408 is therefore radially positioned between the clutch sleeves 406 and 410.

It will be appreciated that the clutch sleeves of the clutch may be independently controlled. As such, the clutch sleeves may be axially moved into their different positions separately or in a coordinated manner in different shifting strategies. The shaft 232 is also shown in FIGS. 4A-4C. The carrier 246 is further shown in FIGS. 4A-4C along with a bearing 411 coupled thereto. An extension 413 of the ring gear 244 is further shown in FIGS. 4A-4C. Actuators 450 and 452 may be configured to independently actuate the clutch sleeves 406 and 410.

FIG. 4A specifically shows the inner clutch sleeve 406 with splines 412 that mate with splines 414 in a section 416 of the shaft 232. In this way, power is transferred from the shaft 224 to the shaft 232 by way of the clutch 230 thereby bypassing the planetary gear set 228. As such, the outer clutch sleeve 410 is decoupled from the planetary gear set 228. FIG. 4A therefore shows the clutch 230 in a positon that places the electric axle in a higher speed mode where the compound planetary gear set is bypassed thereby precluding the planetary gear set from providing another gear reduction. The higher speed mode may therefore be referred to as a second gear that may be used during higher speed vehicle travel.

FIG. 4B specifically shows the clutch 230 with the inner clutch sleeve 406 engaged with the sun gear 238 via splines 418 that mate with splines 420 in the sun gear. To elaborate, the splines 418 are included in an axial extension 422 of the sun gear 238. Additionally, as shown in FIG. 4B, the outer clutch sleeve 410 of the clutch 230 includes splines 424 that mate with splines 426 in the extension 413 of the ring gear 244. The splines 426 are positioned on an inner circumference 428 of the extension 413 of the ring gear 244, in the illustrated example. In this way, the clutch 230 is in a position where mechanical power is transferred from the shaft 224 to the sun gear 238 in the planetary gear set and from the ring gear 244 to the shaft 232. FIG. 4B therefore shows the clutch 230 in a positon that places the electric axle in a lower speed mode where the compound planetary gear set provides another gear reduction. The lower speed mode may therefore be referred to as a first gear that may be used during lower speed vehicle travel such as in off-road environments, in one use-case example.

FIG. 4C shows the clutch 230 in a synchronization position where the splines 418 that begin to engage the splines 420 while the outer clutch sleeve 410 is decoupled from the extension 413 of the ring gear 244. In this way, the speed of the shaft 224 may be speed matched with the sun gear 238 of the compound planetary gear set.

It will be further understood that the clutch 230 may be shifted into a neutral position where the inner clutch sleeve 406 is decoupled from the planetary gear set 228 and the shaft 232 and the outer clutch sleeve 410 is decoupled from the planetary gear set 228. In this way, power from the output shaft to downstream components is able to be selectively inhibited. As such, when the clutch 230 is transitioned into the synchronization position, the ring gear 244 and the input of the differential are speed matched. In this way, noise, vibration, and harshness (NVH) during shifting transients is reduced.

It will be understood that the clutch sleeves 406 and 410 shown in FIGS. 4A-4C may be moved into positions where the sun gear 238 is decoupled from the clutch sleeve 406 such that the splines 418 and 420 are not engaged with one another and where the clutch sleeve 410 is decoupled from the extension 413 of the ring gear 244 such that the splines 424 and 426 are not engaged with one another. This clutch configuration is referred to as the neutral positon as previously mentioned. This neutral clutch position allows losses in in the electric axle to be reduced, thereby increasing electric axle efficiency during certain conditions.

During a shifting transient from the lower speed mode to the higher speed mode, the clutch may be transitioned from the lower speed position to a neutral position where the clutch is decoupled from the sun gear and the ring gear. Next the clutch may be moved into the synchronization position and then from the synchronization position to the higher speed position (depending on the final selected gear). This shifting transient may also occur in the reverse order to shift from the higher speed mode to the lower speed mode. The clutch positions in these modes may be referred to as such.

FIGS. 2-4C are drawn approximately to scale, aside from the schematically depicted components. However, the components may have alternate relative dimensions, in other embodiments.

Further, as discussed herein, the term rotationally coupled refers to a coupling between components that allows torque transfer (and therefore mechanical power flow) therebetween.

FIGS. 1-4C show example configurations with relative positioning of the various components. However, the components may have other relative sizes, in other embodiments. It will be appreciated that if shown directly contacting each other, or directly coupled, then such elements may be referred to as directly contacting or directly coupled, respectively, at least in one example. Similarly, elements shown contiguous or adjacent to one another may be referred to as contiguous or adjacent to each other, respectively, at least in one example. As an example, components laying in face-sharing contact with each other may be referred to as in face-sharing contact. As another example, elements positioned apart from each other with only a space therebetween and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such. Still further in some examples, elements positioned coaxial or parallel to one another may be referred to as such.

The invention is further described in the following paragraphs. In one aspect, an electric axle is provided that comprises a traction motor; an output shaft rotationally coupled to the traction motor via one or more gear reductions; and a clutch system configured to: in a higher speed position, rotationally couple the output shaft and a differential; and in a lower speed position, rotationally couple the output shaft to a sun gear in a planetary gear set and rotationally couple a ring gear in the planetary gear set to the differential; wherein the traction motor is parallel to and offset from the planetary gear set; and wherein the planetary gear set and the differential are coaxially arranged. In one example, the clutch system may be configured to, in a neutral position, rotationally decouple the output shaft and the differential. In another example, the clutch system may be configured to, in a synchronization position, synchronize a speed of the sun gear in the planetary gear set and the output shaft. In another example, the planetary gear set may be a compound planetary gear set. In yet another example, the compound planetary gear set may include: a first set of planet gears that mesh with the sun gear; and a second set of planet gears that mesh with the ring gear. In another example, the differential may be an electronic locking differential. In another example, the electric axle may be a beam axle. In another example, the one or more gear reductions may include a first gear reduction and a second gear reduction. In another example, the first and second gear reductions may each include a gear rotationally mounted on an intermediate shaft. In another example, the clutch system may be axially arranged between the planetary gear set and the differential.

In another aspect, an electric beam axle is provided that comprises a traction motor; and an output shaft rotationally coupled to the traction motor via one or more gear reductions; a clutch system configured to: in a higher speed position, rotationally couple the output shaft and a differential; in a lower speed position, rotationally couple the output shaft to a sun gear in a planetary gear set and rotationally couple a ring gear in the planetary gear set to the differential; in a neutral position, rotationally decouple the output shaft and the differential; and in a synchronization position, synchronize a speed of the sun gear and the output shaft; wherein the traction motor is parallel to and offset from the planetary gear set; and wherein the planetary gear set and the differential are coaxially arranged. In one example, the planetary gear set may be a compound planetary gear set that includes multiple sets of planet gears. In yet another example, the differential may be an electronic locking differential. In another example, the clutch system may include an inner clutch sleeve that includes inner splines that mate with splines on the output shaft. In yet another example, the inner clutch sleeve may include splines that selectively mate with splines on a shaft that is directly rotationally coupled to the differential. In yet another example, the clutch system may include an outer clutch sleeve that includes inner splines that selectively mate with splines on a component that is directly coupled to the ring gear. In another example, the clutch system may include a bearing coupled to the inner clutch sleeve and the outer clutch sleeve. In another example, the one or more gear reductions may include a first gear reduction and a second gear reduction; and the second gear reduction and the clutch system may be arranged on opposing axially sides of the planetary gear set. In another example, the first and second gear reductions may each include a gear rotationally mounted on an intermediate shaft. In yet another example, the differential may be an electronic locking differential.

In another aspect, an electric axle system is provided that comprises a traction motor; a first shaft rotationally coupled to the traction motor via one or more gear reductions; a second shaft arranged coaxial to the first shaft and rotationally coupled to a differential; and a clutch configured to: in a higher speed position, rotationally couple the first shaft and the second shaft; and in a lower speed position, rotationally couple the first shaft to a sun gear in a compound planetary gear set and rotationally couple a ring gear in the compound planetary gear set to the second shaft; wherein the compound planetary gear set and the differential are coaxially arranged; and wherein the compound planetary gear set includes: a first set of planet gears that mesh with the sun gear; and a second set of planet gears that mesh with the ring gear. In one example, the electric axle system may further comprise a controller configured to: shift the clutch between the higher speed position and the lower speed position. In another example, during the shift the clutch between the higher speed position and the lower speed position, the clutch may be moved into a synchronization position where a speed of the sun gear is synchronized with a speed of the first shaft. In another example, in the higher speed position the clutch may rotationally decouple the sun gear from the first shaft and rotationally decouples the ring gear from the second shaft. In another example, in a neutral position the clutch: rotationally decouples the sun gear from the first shaft; rotationally decouples the ring gear from the second shaft; and rotationally decouples the first shaft from the second shaft. In another example, the differential may be an electronic locking differential. In another example, the electric axle may be a beam axle. In another example, the clutch may be axially arranged between the planetary gear set and the differential. In another example, the clutch may include a first clutch sleeve that comprises: inner splines that mate with splines on the first shaft; splines that selectively mate with splines on the second shaft; and splines that selectively mate with the sun gear. In another example, the clutch may include a second clutch sleeve that comprises: inner splines that mate with splines on the second shaft; and splines that selectively mate with splines on the ring gear.

In another aspect, an electric beam axle is provided that comprises: a traction motor; a first shaft rotationally coupled to the traction motor via multiple gear reductions; a second shaft arranged coaxial to the first shaft and rotationally coupled to a differential; and a clutch configured to: in a higher speed position, rotationally couple the first shaft and the second shaft; and in a lower speed position, rotationally couple the first shaft to a sun gear in a compound planetary gear set and rotationally couple a ring gear in the compound planetary gear set to the second shaft; and operate in a neutral position where the clutch: rotationally decouples the sun gear from the first; rotationally decouples the ring gear from the second shaft; and rotationally decouples the first shaft from the second shaft; wherein the compound planetary gear set and the differential are coaxially arranged; and wherein the compound planetary gear set includes: a first set of planet gears that mesh with the sun gear; and a second set of planet gears that mesh with the ring gear. In one example, the clutch may include a clutch sleeve that comprises: inner splines that mate with splines on the first shaft; splines that selectively mate with splines on the second shaft; and splines that selectively mate with the sun gear. In another example, the clutch may include a clutch sleeve that comprises: inner splines that mate with splines on the second shaft; and splines that selectively mate with splines on the ring gear. In another example, the differential may be an electronic locking differential. In another example, the clutch may be axially arranged between the planetary gear set and the differential.

In another aspect, a method for operation of an electric axle system is provided that comprises transitioning a clutch between a higher speed position and a lower speed position; wherein the electric axle system includes: a traction motor; a first shaft rotationally coupled to the traction motor via one or more gear reductions; a second shaft arranged coaxial to the first shaft and rotationally coupled to a differential; and wherein in the higher speed position the clutch rotationally couples the first shaft and the second shaft; and wherein in the lower speed position, the clutch rotationally couples the first shaft to a sun gear in a compound planetary gear set and rotationally couple a ring gear in the compound planetary gear set to the second shaft; wherein the compound planetary gear set and the differential are coaxially arranged; and wherein the compound planetary gear set includes: a first set of planet gears that mesh with the sun gear; and a second set of planet gears that mesh with the ring gear. In one example, during the shift the clutch between the higher speed position and the lower speed position, the clutch may be moved into a synchronization position where a speed of the sun gear is synchronized with a speed of the first shaft. In one example, the clutch may include a first clutch sleeve that comprises: inner splines that mate with splines on the first shaft; splines that selectively mate with splines on the second shaft; and splines that selectively mate with the sun gear; and the clutch includes a second clutch sleeve that comprises: inner splines that mate with splines on the second shaft; and splines that selectively mate with splines on the ring gear. In another example, the clutch may be axially arranged between the planetary gear set and the differential. In yet another example, the first clutch sleeve and the second clutch sleeve are independently actuatable.

In another representation, a multi-speed electric axle is provided that includes two input gear reductions that are rotationally coupled to a compound planetary gear set that is rotationally coupled to a differential and a clutch assembly configured to direct power around the compound planetary gear set in a lower gear mode and directs power through the compound planetary gear set in a higher gear mode.

Note that the example control and estimation routines included herein can be used with various powertrain, transmission, and/or vehicle system configurations. The control methods and routines disclosed herein may be stored as executable instructions in non-transitory memory and may be carried out by the control system including the controller in combination with the various sensors, actuators, and other vehicle hardware. Further, the described actions, operations and/or functions may graphically represent code to be programmed into non-transitory memory of the computer readable storage medium in the vehicle control, where the described actions are carried out by executing the instructions in a system including the various hardware components in combination with the electronic controller. One or more of the method steps described herein may be omitted if desired.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, these specific examples are not to be considered in a limiting sense, because numerous variations are possible. For example, the above technology can be applied to powertrains that include different types of propulsion sources including different types of electric machines and internal combustion engines. The subject matter of the present disclosure includes all novel and non-obvious combinations and sub-combinations of the various systems and configurations, and other features, functions, and/or properties disclosed herein.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electric axle system, comprising:
a traction motor;
a first shaft rotationally coupled to the traction motor via one or more gear reductions;
a second shaft arranged coaxial to the first shaft and rotationally coupled to a differential; and
a clutch configured to:
in a higher speed position, rotationally couple the first shaft and the second shaft; and
in a lower speed position, rotationally couple the first shaft to a sun gear in a compound planetary gear set and rotationally couple a ring gear in the compound planetary gear set to the second shaft;
wherein the compound planetary gear set and the differential are coaxially arranged; and
wherein the compound planetary gear set includes:
a first set of planet gears that mesh with the sun gear; and
a second set of planet gears that mesh with the ring gear.

2. The electric axle system of claim 1, further comprising a controller configured to:
shift the clutch between the higher speed position and the lower speed position.

3. The electric axle system of claim 2, wherein during the shift the clutch between the higher speed position and the lower speed position, the clutch is moved into a synchronization position where a speed of the sun gear is synchronized with a speed of the first shaft.

4. The electric axle of claim 1, wherein in the higher speed position the clutch rotationally decouples the sun gear from the first shaft and rotationally decouples the ring gear from the second shaft.

5. The electric axle of claim 1, wherein in a neutral position the clutch:
rotationally decouples the sun gear from the first shaft;
rotationally decouples the ring gear from the second shaft; and
rotationally decouples the first shaft from the second shaft.

6. The electric axle system of claim 1, wherein the differential is an electronic locking differential.

7. The electric axle system of claim 1, wherein the electric axle is a beam axle.

8. The electric axle of claim 1, wherein the clutch is axially arranged between the compound planetary gear set and the differential.

9. The electric axle system of claim 1, wherein the clutch includes a first clutch sleeve that comprises:
inner splines that mate with splines on the first shaft;
splines that selectively mate with splines on the second shaft; and
splines that selectively mate with the sun gear.

10. The electric axle system of claim 9, wherein the clutch includes a second clutch sleeve that comprises:
inner splines that mate with splines on the second shaft; and
splines that selectively mate with splines on the ring gear.

11. An electric beam axle, comprising:
a traction motor;
a first shaft rotationally coupled to the traction motor via multiple gear reductions;
a second shaft arranged coaxial to the first shaft and rotationally coupled to a differential; and
a clutch configured to:
in a higher speed position, rotationally couple the first shaft and the second shaft; and
in a lower speed position, rotationally couple the first shaft to a sun gear in a compound planetary gear set and rotationally couple a ring gear in the compound planetary gear set to the second shaft; and
operate in a neutral position where the clutch:
rotationally decouples the sun gear from the first;
rotationally decouples the ring gear from the second shaft; and
rotationally decouples the first shaft from the second shaft;
wherein the compound planetary gear set and the differential are coaxially arranged; and
wherein the compound planetary gear set includes:
a first set of planet gears that mesh with the sun gear; and
a second set of planet gears that mesh with the ring gear.

12. The electric beam axle of claim 11, wherein the clutch includes a clutch sleeve that comprises:
inner splines that mate with splines on the first shaft;
splines that selectively mate with splines on the second shaft; and
splines that selectively mate with the sun gear.

13. The electric beam axle of claim 11, wherein the clutch includes a clutch sleeve that comprises:
inner splines that mate with splines on the second shaft; and
splines that selectively mate with splines on the ring gear.

14. The electric beam axle of claim 11, wherein the differential is an electronic locking differential.

15. The electric beam axle of claim 14, wherein the clutch is axially arranged between the compound planetary gear set and the differential.

16. A method for operation of an electric axle system, comprising:
transitioning a clutch between a higher speed position and a lower speed position;
wherein the electric axle system includes:
a traction motor;
a first shaft rotationally coupled to the traction motor via one or more gear reductions;
a second shaft arranged coaxial to the first shaft and rotationally coupled to a differential; and
wherein in the higher speed position the clutch rotationally couples the first shaft and the second shaft; and
wherein in the lower speed position, the clutch rotationally couples the first shaft to a sun gear in a compound planetary gear set and rotationally couple a ring gear in the compound planetary gear set to the second shaft;
wherein the compound planetary gear set and the differential are coaxially arranged; and
wherein the compound planetary gear set includes:
a first set of planet gears that mesh with the sun gear; and
a second set of planet gears that mesh with the ring gear.

17. The method of claim 16, wherein during the shift the clutch between the higher speed position and the lower speed position, the clutch is moved into a synchronization position where a speed of the sun gear is synchronized with a speed of the first shaft.

18. The method of claim 16, wherein:
the clutch includes a first clutch sleeve that comprises:
inner splines that mate with splines on the first shaft;
splines that selectively mate with splines on the second shaft; and
splines that selectively mate with the sun gear; and
the clutch includes a second clutch sleeve that comprises:
inner splines that mate with splines on the second shaft; and
splines that selectively mate with splines on the ring gear.

19. The method of claim 18, wherein the clutch is axially arranged between the planetary gear set and the differential.

20. The method of claim 18, wherein the first clutch sleeve and the second clutch sleeve are independently actuatable.
